(19) United States
(12) Patent Application Publication
(10) Pub. No.: US 2024/0161051 A1
(43) Pub. Date: May 16, 2024

(54) SYSTEM AND PROCESS FOR DOCUMENTING THE DISTRIBUTION OF DURABLE MEDICAL EQUIPMENT (DME)

(71) Applicant: Rx Redefined, Inc., Oakland, CA (US)

(72) Inventors: Ellen Radloff, Oakland, CA (US); Jayme Hanson, Oakland, CA (US); Erik Smith, Oakland, CA (US); Brandon Boots, Oakland, CA (US)

(73) Assignee: RX Redefined, Inc., Oakland, CA (US)

(21) Appl. No.: 18/389,165

(22) Filed: Nov. 13, 2023

Related U.S. Application Data
(60) Provisional application No. 63/425,815, filed on Nov. 16, 2022.

(51) Int. Cl. G06Q 10/0833; G06V 40/30; H04L 9/40

(52) U.S. Cl. CPC G06Q 10/0833; G06V 40/30; H04L 63/0807

(57) ABSTRACT

A method and system documenting the distribution of durable medical equipment (DME) is disclosed. A user authenticates their access via an authentication token and enters or scans a unique identifier from one or more physical supply boxes that have been previously designated for distribution to patients. This unique identifier and the authentication token are sent to a server. The server validates the unique identifier and authentication token and responds with a collection of data necessary to document a proof of transaction. The collection of data is presented in an electronic format to the patient who reviews the data and electronically signs for the DME products. The signature, collection of data, user authentication token, and a timestamp are then sent back to the server for storage in memory in a Proof of Delivery file.

### CROSS-REFERENCE TO RELATED APPLICATIONS

This application claims priority under 35 U.S.C. Section 119(e) to co-pending U.S. Provisional Patent Application No. 63/425,815, entitled “SYSTEM AND PROCESS FOR DOCUMENTING THE DISTRIBUTION OF DURABLE MEDICAL EQUIPMENT (DME)” and filed on Nov. 16, 2022, the entire disclosure of which is incorporated herein by reference.

### FIELD OF THE INVENTION

The present invention and disclosure are generally directed to the production of documentation for the distribution of durable medical equipment (“DME”) supplies.

### BACKGROUND OF THE INVENTION

Home medical equipment is a category of devices used by patients whose care is being managed from a home or other private facility managed by a non-professional caregiver or family member. It is often referred to as “durable” medical equipment (DME), as it is intended to withstand repeated use and is appropriate for use in the home.

Conventionally, a physician writes a prescription for DME supplies and recommends a third-party supplier to the patient. The patient is then required to coordinate the on-going distribution of these products to their home or private facility. For example, this is analogous to receiving a prescription for medical drugs and the subsequent coordination that occurs between a patient and a pharmacy.

However, when a patient receives DME products directly from their physician, the prescribing physician is often required to document this transaction in what is referred to as a “Proof of Delivery”. A physician supplier of DME products is required to create the Proof of Delivery file, usually by collecting the relevant data and documentation manually from several sources and presenting this documentation for signature to the patient or the patient's authorized representative.

Manually producing this documentation, such that it accurately reflects all requirements of the Durable Medical Equipment, Prosthetics/Orthotics & Supplies (“DMEPOS”) standards as set forth by the Department of Health and Human Services (HHS), is error-prone and cumbersome.

Further, manually producing this documentation also provides no assurances to the provider, the patient, regulatory bodies, or insurance payers that the Proof of Delivery file accurately reflects the DME products supplied.

### BRIEF SUMMARY OF THE INVENTION

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

The inventions disclosed herein provide a method and system for electronically and accurately compiling all necessary data and documentation to produce an electronic “Proof of Delivery” file, that is subsequently signed by the patient or their representative receiving these products.

The inventions and disclosure overcome known problems by: a) identifying the exact inventory supplies intended to be provided to the patient via a unique identifier; b) using this identifier to securely fetch the associated data required to be present on the Proof of Delivery file; c) enabling the patient to sign for DME products electronically; and d) ultimately, producing a signed Proof of Delivery file that satisfies the DMEPOS standards and related regulations.

In one embodiment, a unique identifier such as a bar code or human readable identifier is physically included on or within a box or set of boxes containing DME products that have been previously designated for pick-up by a patient at a clinical location. A data-matching algorithm can be used in which the unique identifier is electronically communicated to an internal or external processing server, such as over the Internet via a secure protocol, along with necessary authentication tokens, to subsequently respond with a set of data that comprises a “Proof of Delivery” document, that has been collected in a previous set of processes.

In this embodiment, this data can include: (a) Patient Name, date of birth (“DOB”), or any multiple patient identifiers sufficient to uniquely identify the patient; (b) detailed descriptions of the products delivered, including either product SKUs or medical Healthcare Common Procedure Coding System (“HCPCS”) codes; (c) and the carrier and tracking information, date of delivery, and unit count of products.

The presentation of this data, in electronic form, in which the patient receiving the products is able to review this data and electronically sign over possession of the associated boxes of DME product, provides an inherent link between the signed Proof of Delivery file and the products being delivered to the patient according to the DMEPOS standards.

In another embodiment, this invention and disclosure applies a digital mechanism for completion, in which each step is necessarily dependent on the previous, to produce a piece of documentation that is required, to facilitate the delivery of DME products in a clinical setting. Further, the invention enables the supply of DME products in a clinical setting using electronic and digital processing.

In another embodiment, for an inventory or fulfillment system, a clinical location receives DME products that have been allocated for receipt by a patient. Typically, this arrives via a third-party carrier such as FedEx or UPS. The office staff of the clinic then arranges a time for pick-up by the patient. Just prior to a patient arriving to pick up supplies, the office staff or other user securely authenticates with the system.

Next, the user identifies the packages via a unique identifier, such as via a human readable identifier or barcode-like mechanism, and queries for the Proof of Delivery data associated with that unique identifier. Upon arrival, the patient or their authorized representative is presented with an electronic Proof of Delivery file for their review and electronic signature. The signature, along with the Proof of Delivery Data, is time stamped and stored as an electronic record alongside or in reference to, by the processing server.

In another embodiment, the invention and disclosure herein allows physicians to document the supply of DME in an office or clinical setting while: (1) adhering to a set of legal standards regarding the distribution of supplies in an office or clinical setting; (2) adhering to a set of legal standards regarding the requirements for supplying DME products in an office or clinical setting, commonly referred to as the “In-Office Ancillary Exception” (42 CFR § 411.355); and (3) providing the needed Proof of Delivery documentation when replying to a challenge by the payor.

In another embodiment, in the context of a system and process for documenting the supply of DME in an office or clinical setting, the embodiments described herein may keep physician suppliers in compliance with DMEPOS standards. Throughout the electronic documentation process, the platform can ensure the physician and their staff adheres to DMEPOS standards, including documenting an accurate Proof of Delivery of DME supplies. The platform captures an electronic signature of the patient being distributed the products, indicating their acceptance of the transaction.

In another embodiment, physician suppliers can be kept in compliance with legal requirements for supplying DME products in an office or clinical setting. Specifically, the electronic documentation process assists the physician supplier by ensuring the products being suppled meet the “purpose of ambulation” prior to distribution; ensuring the products being furnished meet the “same building” requirement, by preventing the Proof of Delivery transaction from occurring if these guidelines are not met, based on the original prescribing physician and the location at which the supplies are being distributed, as collected from the server via the shipment data; and ensuring the distribution of products are overseen by a physician supplier or their staff.

In another embodiment, the rate of insurance denials can be decreased by ensuring accurate and timely documentation of the Proof of Delivery of DME supplies, which is often required by insurance payers for reimbursement of funds.

Other objects, features, and advantages of the present invention will become apparent upon consideration of the following detailed description and the accompanying drawings.

### BRIEF DESCRIPTION OF THE DRAWINGS

FIG. 1 illustrates an example embodiment of a system for use with documenting the distribution of DME products.

FIG. 2 shows an example embodiment of a disclosed method and process of documenting the distribution of DME products.

FIG. 3 illustrates example embodiments of a unique identifier that can be used with the disclosed method and process of documenting the distribution of DME products.

FIG. 4 illustrates one example embodiment of how a collection of data may be displayed on a physician device with the disclosed method and process of documenting the distribution of DME products.

### DETAILED DESCRIPTION OF THE INVENTION

The following is a detailed description of various embodiments to illustrate the principles of the invention. The embodiments are provided to illustrate aspects of the invention, but the invention is not limited to any embodiment. The scope of the invention encompasses numerous alternatives, modifications, and equivalents. The scope of the invention is limited only by the claims.

While numerous specific details are set forth in the following description to provide a thorough understanding of the invention, the invention may be practiced according to the claims without some or all of these specific details.

Various embodiments will be described in detail with reference to the accompanying drawings. Wherever possible, the same reference numbers are used throughout the drawings to refer to the same or like parts. References made to particular examples and implementations are for illustrative purposes and are not intended to limit the scope of the claims.

The example embodiments presented herein are directed to a system and process for documenting the distribution of DME supplies and products. In one embodiment, a system and process for documenting the distribution of DME supplies and products is disclosed. A user utilizes an electronic device referred to as a physician device to specify a physical supply box (“Shipment”) from a set of designated inventory via a unique identifier. The physician device then queries a server requesting the details associated with that Shipment to produce the data needed to generate documentation known as a “Proof of Delivery”. The patient, care giver, or other authorized patient representative to whom the Shipment is intended reviews and subsequently electronically signs the Proof of Delivery; that transaction, including the signature, are sent to the server for long-term storage in memory.

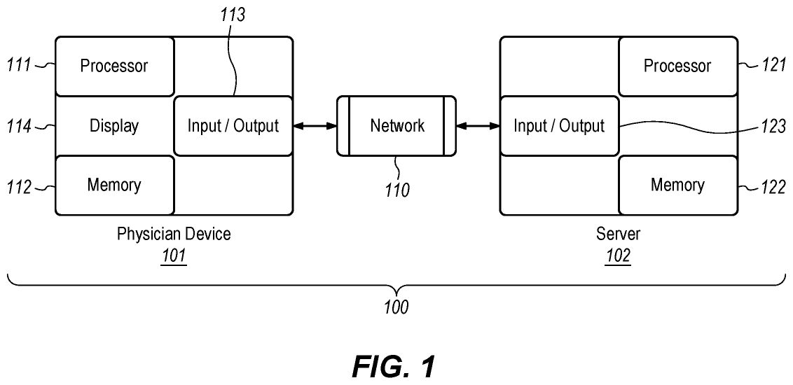

FIG. 1 illustrates one embodiment of a system 100 for documenting the distribution of DME supplies and products. As shown in FIG. 1, system 100 includes a physician device 101, a server 102, and a network 110 such as an internet protocol, a local area network, or a direct network connection. The physician device 101, the server 102 and the network 110 are used for implementing the techniques disclosed herein.

The physician device 101 includes a processor 111, which can include one or more processing devices. Examples of processor 111 include without limitation a microprocessor, an application-specific integrated circuit (ASIC), a state machine, or other suitable processing device. Processor 111 is communicatively coupled to a computer-readable storage medium, such as memory 112, and accesses information stored in memory 112. Memory 112 also stores computer-executable instructions that when executed by processor 111 cause the processor 111 to perform the operations described herein. Memory 112 may be, for example, solid-state memories, optical and magnetic media or any other non-transitory machine-readable medium. Non-limiting examples of memory 112 include a hard drive, compact disc, flash memory, non-volatile memory, volatile memory, magnetic disk(s), etc. Physician device 101 also includes an input/output 113 including, for example, a wireless transmitter and a wireless receiver, and clock for generating timestamps. Physician device 101 also includes a display 114, such as a screen or other viewing means. In various embodiments, physician device 101 can be without limitation a desktop computer, laptop computer, electronic tablet, cellular phone, PDA, or other similar hand-held or desktop electronic device.

The server 102 includes a processor 121, which can include one or more processing devices. Examples of processor 121 include without limitation a microprocessor, an application-specific integrated circuit (ASIC), a state machine, or other suitable processing device. Processor 121 is communicatively coupled to a computer-readable storage medium, such as memory 122, and accesses information stored in memory 122. Memory 122 also stores computer-executable instructions that when executed by processor 121 cause the processor 121 to perform the operations described herein. Memory 122 may be, for example, solid-state memories, optical and magnetic media or any other non-transitory machine-readable medium. Non-limiting examples of memory 122 include a hard drive, compact disc, flash memory, non-volatile memory, volatile memory, magnetic disk(s), etc. Server 102 also includes an input/output 123 including, for example, a wireless transmitter and a wireless receiver, and clock for generating timestamps.

FIG. 1 is one example embodiment of a particular implementation and is merely to illustrate the types of components that may be present in system 100. While the physician device 101 and the server 102 are illustrated with various components, it is not intended to represent any particular architecture or manner of interconnecting the components. It will be appreciated by one of skill in the art that network computers, handheld computers, mobile phones, servers, and/or other data processing systems which have fewer components or perhaps more components may also be used with the embodiments herein.

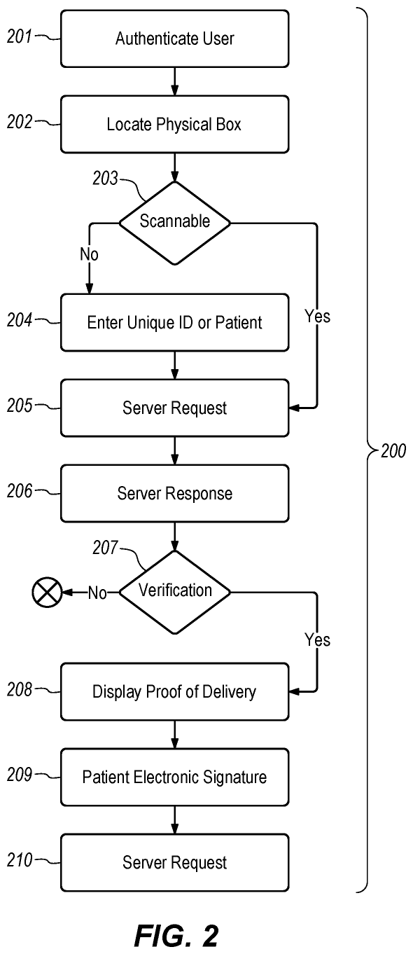

While the documentation process 200 described, for example in FIG. 2 and below, can be implemented using the hardware of system 100 of FIG. 1, the processes described herein are not limited to use only with the hardware of system 100.

FIG. 2 shows documentation process 200 for documenting the distribution of DME products in an office or clinical setting using physician device 101 and server 102 of system 100 as shown in FIG. 1. Documentation process 200 can be performed by the physician device 101 and the server 102. Server 102 can be an internal or external processing server to physician device 101.

As shown in FIG. 2, at step 201 of documentation process 200, a user such as a physician or an office or other clinical staff member authenticates themselves with a user authentication token using physician device 101.

At step 202, the user identifies a Shipment from a set of product inventory that has been designated for a particular patient using one of two methods in steps 203 and 204, and using unique identifier 300.

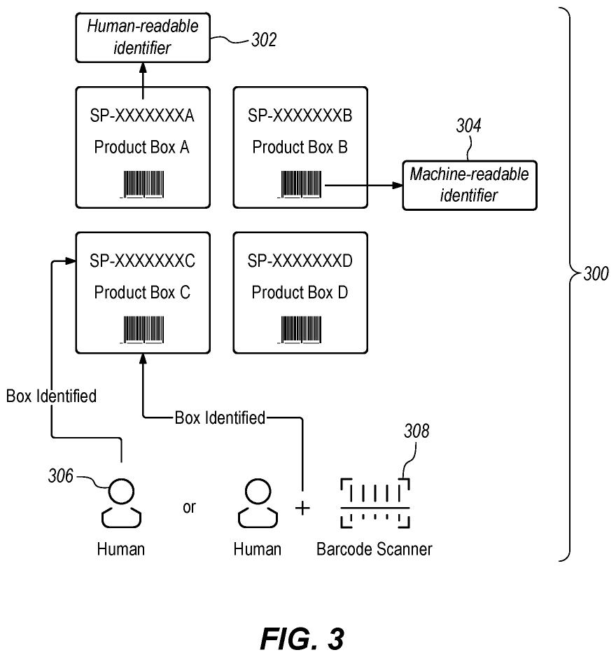

As shown in FIG. 3, unique identifier 300 can be a human-readable identifier 302 such as, but not limited to, a purchase order (“PO”), reference ID, or patient name all readable by human 306. Or, unique identifier 300 can be a proprietary or non-proprietary machine-scannable identifier 304, such as a bar code readable by barcode scanner 308.

Going back to FIG. 2, step 203 of documentation process 200 uses a machine-scannable identifier 304 as the unique identifier 300. If unique identifier 300 is a human-readable identifier 302, then documentation process 200 moves to step 204 and uses a human-readable identifier 304 as the unique identifier 300.

At step 205 of documentation process 200 as shown in FIG. 2, once unique identifier 300 has been determined by either step 203 or step 304, a request with the unique identifier 300, along with the previously captured authentication token in step 201, is sent to server 102. If server 102 is external to physician device 101, the sending can be done using a computer protocol over network 110.

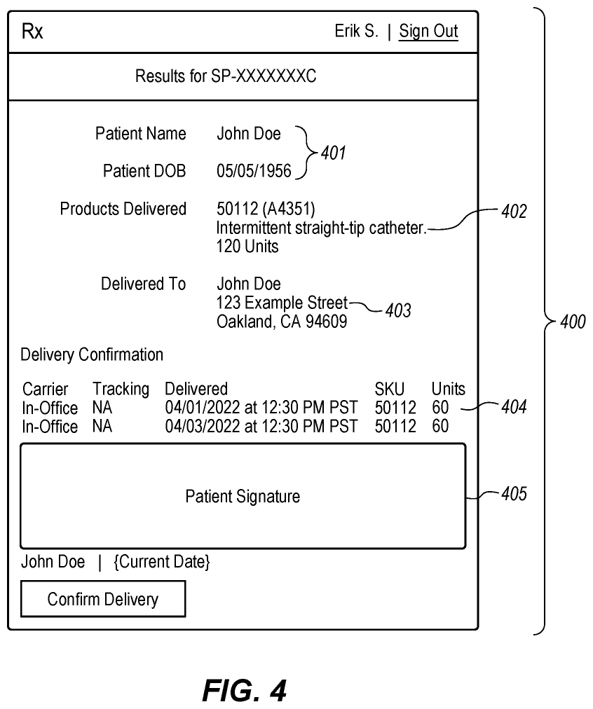

At step 206, server 102 processes the request and verifies the unique identifier 300 and user authentication token. If the unique identifier 300 matches a previously established electronic record, and the authenticated user has acceptable permissions to interact with the unique identifier 300 and its associated collection of data 400 (FIG. 4), server 102 responds by providing the collection of data 400.

As step 207, if the verification process fails, the server responds with an appropriate error message and documentation process 200 ends. If the verification process at step 207 is successful, documentation process 200 continues to step 208.

At step 208, physician device 101 displays the collection of data 400 associated with the unique identifier 300 on display 114 of physician device 101.

At step 209, the patient or their authorized representative receiving the Shipment reviews the collection of data 400 presented on display 114 and provides an electronic signature with a timestamp as part of signature 405 to confirm the transaction.

At step 210, a Proof of Delivery file comprising the electronic signature and timestamp captured in signature 405, the unique identifier 300, collection of data 400, and the User authentication token are sent back to the server 102 to be stored in memory 122.

FIG. 4 illustrates an example embodiment of how collection of data 400 may be displayed on display 114 of physician device 101, including patient data 401, products delivered 402, delivery address 403, delivery confirmation 404, and signature 405 which can include an electronic signature of the patient and a timestamp. In other embodiments, other displays of collection of data 400 may be used.

In one embodiment, patient data 401 can include a patient's name, DOB, or medical record number capable of identifying a unique patient. Products delivered 402 can include a detailed descriptions of the products contained in the Shipment being distributed to the patient, either brand-name Product SKUs or medical HCPCS codes. Delivery address 403 can include the address at which the Shipment is being distributed. Delivery confirmation 404 can include details regarding the date and time of the delivery of the products, including the number of units distributed. Signature 405 can include a patient's signature and timestamp.

Some portions of the preceding detailed descriptions have been presented in terms of algorithms. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a mobile device, or similar electronic device, that manipulates and transforms data represented as physical (electronic) quantities within the system's registers and memories into other data similarly represented as physical quantities within the system memories or registers or other such information storage, transmission or display devices.

The processes and blocks described herein are not limited to the specific examples described and are not limited to the specific orders used as examples herein. Rather, any of the processing blocks may be re-ordered, combined or removed, performed in parallel or in serial, as necessary, to achieve the results set forth above. The processing blocks associated with implementing the system may be performed by one or more programmable processors executing one or more computer programs stored on a non-transitory computer readable storage medium to perform the functions of the system. All or part of the system may be implemented as, special purpose logic circuitry (e.g., an FPGA (field-programmable gate array) and/or an ASIC (application-specific integrated circuit)). All or part of the system may be implemented using electronic hardware circuitry that include electronic devices such as, for example, at least one of a processor, a memory, a programmable logic device or a logic gate. Further, processes can be implemented in any combination hardware devices and software components.

While certain embodiments have been described and shown in the accompanying drawings, it is to be understood that such embodiments are merely illustrative of and not restrictive, and are not limited to the specific constructions and arrangements shown and described, since various other modifications may occur to those of ordinary skill in the art. The description is thus to be regarded as illustrative instead of limiting.

What is claimed:

1. A method of documenting the distribution of durable medical equipment (DME), the method comprising:
authenticating a user on a physician device with a user authentication token;
determining a unique identifier for an inventory supply box containing one or more durable medical equipment products, wherein the one or more durable medical equipment products are designated for a patient, and wherein the unique identifier is associated with a collection of data stored in a memory of a server;
sending an electronic request with the unique identifier and user authentication token to the server,
verifying the unique identifier and the user authentication token by the server;
accessing the collection of data stored in the memory and associated with the unique identifier;
returning the collection of data to the physician device;
displaying the collection of data in an electronic format on a display of the physician device;
obtaining on the physician device an electronic signature of the patient receiving the inventory supply box and a timestamp, wherein the timestamp represents a date and time of the electronic signature; and
sending the electronic signature, the timestamp, the unique identifier, the collection of data, and the user authentication token to the server for storage in the memory.

2. The method of claim 1 wherein the unique identifier comprises a human readable identifier.

3. The method of claim 1 wherein the unique identifier comprises a machine readable identifier.

4. The method of claim 1 wherein the collection of data comprises an individual identifier to identify the patient.

5. The method of claim 1 wherein the collection of data comprises a description of the one or more durable medical equipment products.

6. The method of claim 1 wherein the collection of data comprises a number of the one or more durable medical equipment products.

7. The method of claim 1 wherein the electronic signature, the timestamp, the unique identifier, the collection of data, and the user authentication token are stored together in the memory as a Proof of Delivery file.

8. The method of claim 1 wherein the electronic request with the unique identifier and user authentication token are sent to the server via an internet protocol.

9. The method of claim 1 wherein the electronic request with the unique identifier and user authentication token are sent to the server via a local area network.

10. The method of claim 1 wherein the electronic request with the unique identifier and user authentication token are sent to the server via a direct network connection.
